(19) United States
(12) Patent Application Publication
(10) Pub. No.: US 2014/0081941 A1
(43) Pub. Date: Mar. 20, 2014

(54) SEMANTIC RANKING USING A FORWARD INDEX

(71) Applicant: MICROSOFT CORPORATION, Redmond, WA (US)

(72) Inventors: JING BAI, LOS GATOS, CA (US); HUI SHEN, BEIJING (CN); XIAO-SONG YANG, BEIJING (CN); MAO YANG, BEIJING (CN); YUE-SHENG LIU, BEIJING (CN); JAN OTTO PEDERSEN, LOS ALTOS HILLS, CA (US)

(73) Assignee: MICROSOFT CORPORATION, REDMOND, WA (US)

(21) Appl. No.: 13/709,838

(22) Filed: Dec. 10, 2012

(30) Foreign Application Priority Data
Sep. 14, 2012 (CN) 2012081376

(51) Int. Cl. G06F 17/30

(52) U.S. Cl. CPC G06F 17/30011; G06F 17/30864
USPC 707/706; 707/723

(57) ABSTRACT

Methods, computer systems, and computer-readable media for generating semantic ranking features using a forward index are provided. A search query is received and is analyzed for one or more semantic units including semantic patterns, topical categories, and entities. A forward index comprising a plurality of documents is accessed and semantic units associated with each of the documents are analyzed. The semantic units include semantic patterns, topical categories, unigrams, bigrams, and entities. Documents who share substantially similar semantic units with the search query are identified, and the ranking of the identified documents is adjusted based on the substantially similar semantic units.

### CROSS-REFERENCE TO RELATED APPLICATIONS

This application claims priority to International Patent Application No. PCT/CN2012/081376, filed Sep. 14, 2012 and entitled “Semantic Ranking Using a Forward Index,” which application is hereby incorporated by reference as set forth in its entirety herein.

### BACKGROUND

Traditional search ranking algorithms rely on an inverted index to match keywords extracted from search queries to keywords associated with one or more documents. Inverted indices store a mapping from content, such as keywords, to its location in a database file, or in a document or set of documents. These types of indices only support query-independent document analysis, since documents are analyzed before the query is known. By way of example, a document may be analyzed for one or more keywords. The keywords are extracted, and a mapping between the keywords and the document is stored in the inverted index. Subsequently, a search query is received, and keywords are extracted from the search query. The search query keywords are matched to corresponding keywords in the inverted index, and the documents mapped to the keywords are retrieved. Other types of information that may be gleaned from the document, such as semantic or contextual information, are restricted due to index-size limitations of the inverted index.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the present invention relate to systems, methods, and computer-readable media for, among other things, generating semantic ranking features using a forward or per-document index (PDI). A forward index uses forward (in-order) encoding that preserves the semantic and contextual information of the original document including keywords and non-keyword terms; this semantic information provides valuable indicators as to the underlying meaning of the document. The forward index is structured in such a way that rich per-document information, including semantic and/or contextual information, of different kinds can be accessed and utilized at the time a search query is received without significant search-time penalties. Thus, when a search query is received, semantic units associated with the search query are analyzed and compared to semantic units associated with documents in the forward index. Documents that share similar semantic units with the search query are ranked higher when returned as search results. Thus, the use of semantic information with respect to search queries and documents enables the creation of new semantic ranking features which results in improved relevance of search results.

Accordingly, in one aspect, the present invention is directed to one or more computer-readable media storing computer-useable instructions that, when used by one or more computing devices, cause the one or more computing devices to perform a method of generating semantic ranking features using a forward index. The method comprises receiving a search query and analyzing, using the one or more computing devices, one or more semantic units associated with the search query. A forward index comprising a plurality of documents is accessed. One or more semantic units associated with each document of the plurality of documents are analyzed. One or more documents in the plurality of documents whose semantic units are substantially similar to the one or more semantic units associated with the search query are identified. The ranking of the one or more documents is adjusted based on the substantially similar one or more semantic units.

In another aspect, the present invention is directed to a system for generating semantic ranking features. The system comprises a computing device associated with a search engine having one or more processors and one or more computer-readable storage media, and a forward index coupled with the search engine. The search engine receives a search query and analyzes one or more semantic units associated with the search query. The search engine also analyzes one or more semantic units associated with a set of documents stored in association with the forward index data store. One or more documents in the set of documents whose semantic units substantially match the one or more semantic units associated with the search query are identified, and the ranking of the one or more documents is modified based on the substantially matched semantic units.

In yet another aspect, the present invention is directed to a computerized method carried out by a search engine running on one or more processors for ranking a document on a search engine results page using a forward index. The method comprises receiving a search query and analyzing, using the one or more processors, one or more semantic units associated with the search query. The one or more semantic units comprise semantic patterns associated with the search query, topical categories associated with the search query, and one or more entities associated with the search query. A forward index comprising a plurality of documents is accessed and one or more semantic units associated with each document of the plurality of documents are analyzed. The one or more semantic units comprise semantic patterns associated with the each document of the plurality of documents, topical categories associated with the each document of the plurality of documents, and one or more entities associated with the each document of the plurality of documents. One or more documents in the plurality of documents whose one or more semantic units are substantially similar to the one or more semantic units associated with the search query are identified. The one or more documents are ranking higher based on the substantially similar semantic units.

### BRIEF DESCRIPTION OF THE DRAWINGS

The present invention is described in detail below with reference to the attached drawings figures, wherein:

FIG. 1 is a block diagram of an exemplary computing environment suitable for use in implementing embodiments of the present invention;

FIG. 2 is a block diagram of an exemplary system for generating semantic ranking features using a forward index suitable for use in implementing embodiments of the present invention;

FIG. 3 is a flow diagram that illustrates an exemplary method of generating semantic ranking features using a forward index in accordance with an embodiment of the present invention; and

FIG. 4 is a flow diagram that illustrates an exemplary method of ranking a document on a search engine results page using a forward index in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present invention relate to systems, methods, and computer-readable media for, among other things, generating semantic ranking features using a forward or per-document index (PDI). A forward index uses forward (in-order) encoding that preserves the semantic and contextual information of the original document including keywords and non-keyword terms; this semantic information provides valuable information as to the underlying meaning of the document. The forward index is structured in such a way that rich per-document information, including semantic and/or contextual information, of different kinds can be accessed and utilized at the time a search query is received without significant search-time penalties. Thus, when a search query is received, semantic information associated with the search query is analyzed and compared to semantic information associated with documents in the forward index. Documents that share similar semantic units with the search query are ranked higher when returned as search results. Thus, the use of semantic information with respect to search queries and documents enables the creation of new semantic ranking features which results in improved relevance of search results.

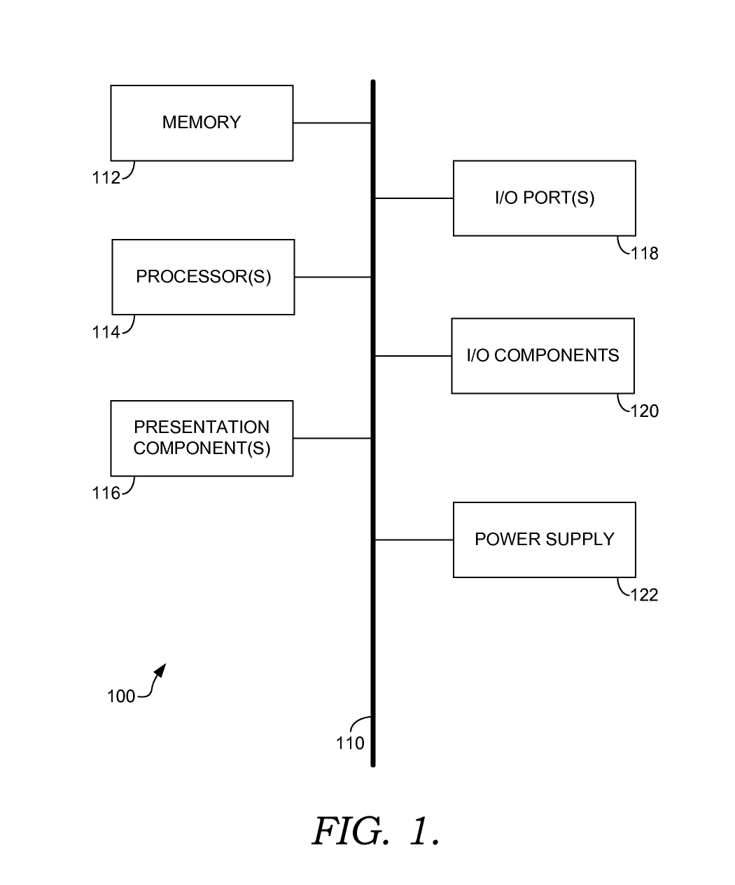

An exemplary computing environment suitable for use in implementing embodiments of the present invention is described below in order to provide a general context for various aspects of the present invention. Referring to FIG. 1, such an exemplary computing environment is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, a camera, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a Web browser, a set of one or more processes distributed on one or more computers, one or more stand-alone storage devices, a set of one or more other computing or storage devices, a combination of one or more of the above, and the like.

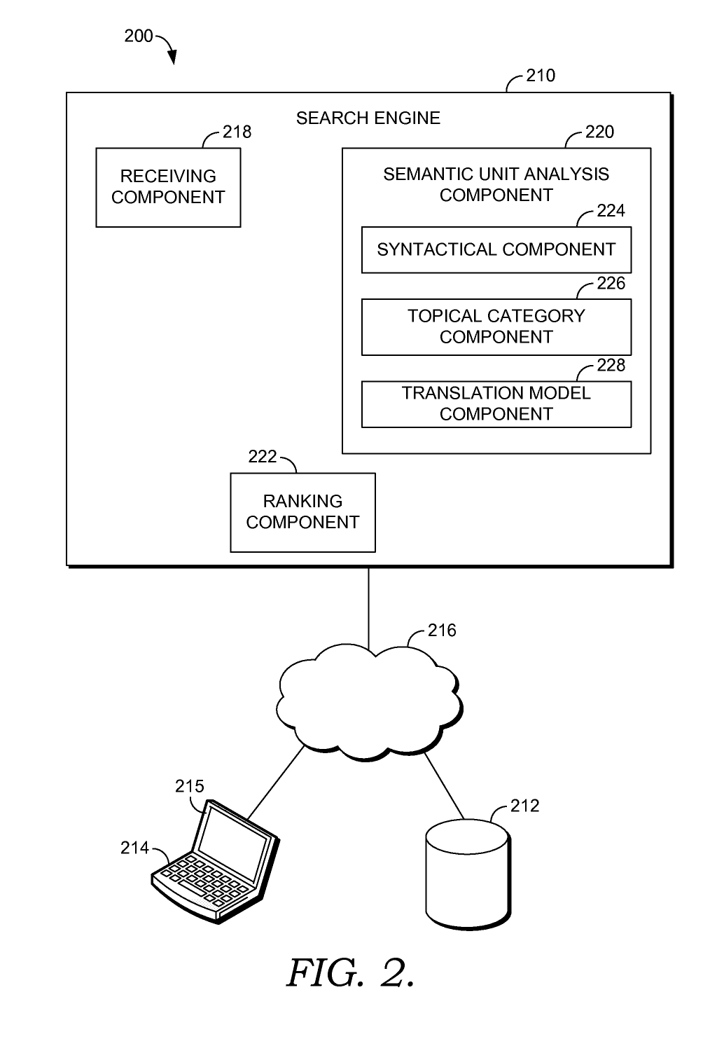

With this as a background and turning to FIG. 2, an exemplary system 200 is depicted for use in generating semantic ranking features using a forward index. The system 200 is merely an example of one suitable system environment and is not intended to suggest any limitation as to the scope of use or functionality of embodiments of the present invention. Neither should the system 200 be interpreted as having any dependency or requirement related to any single module/component or combination of modules/components illustrated therein.

The system 200 includes a search engine 210, a data store 212, and an end-user computing device 214 all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

In some embodiments, one or more of the illustrated components/modules may be implemented as stand-alone applications. In other embodiments, one or more of the illustrated components/modules may be integrated directly into, for example, the operating system of the end-user computing device 214 or the search engine 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the search engine 210 might reside on a server, a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 212 is configured to store information for use by, for example, the search engine 210. In one aspect, the data store 212 is configured as a per-document index (PDI) or forward index (for the purposes of this application, the two terms are used interchangeably) that stores documents that may be returned by the search engine 210 as search results. A document comprises a Web page, a collection of Web pages, representations of documents (e.g., a PDF file), and the like. A forward index uses in-order encoding that preserves not only the keywords associated with the original document but also the contextual information associated with the document including the contextual order of the document. The forward index is structured in such a way as to allow access to both keyword terms and the context surrounding those terms at the time the search query is received without significant search-time penalties. Preservation of the contextual information of the original document further enables the use of natural language processing to process document information.

The information stored in association with the data store 212 is configured to be searchable for one or more items of information stored in association therewith. The information stored in association with the data store 212 may comprise general information used by the search engine 210. For example, the data store 212 may store information concerning recorded search behavior (query logs, rating logs, browser or search logs, query click logs, related search lists, etc.) of users in general, and a log of a particular user's tracked interactions with the search engine 210. Query click logs provide information on documents selected by users in response to a search query, while browser/search logs provide information on documents viewed by users during a search session and how frequently any one document is visited by users. Additionally, rating logs indicate an importance or ranking of a document based on, for example, various rating algorithms known in the art.

The data store 212 is also configured to store data structures such as entity relationship graphs. The term entity is meant to be broad and encompass any item or concept that can be uniquely identified. Entity relationship graphs typically comprise a set of nodes with each node corresponding to an entity. The distance between two different entity nodes on the graph may provide an indication of the likelihood or probability that the entities associated with those nodes occur together in the real world.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the search engine 210, the end-user computing device 214, and/or any combination thereof.

The end-user computing device 214 shown in FIG. 2 may be any type of computing device, such as, for example, the computing device 100 described above with reference to FIG. 1. By way of example only and not limitation, the end-user computing device 214 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof. The end-user computing device 214 may receive inputs through a variety of means such as voice, touch, and/or gestures. As shown, the end-user computing device 214 includes a display screen 215. The display screen 215 is configured to present information, including search results, to the user of the end-user computing device 214.

The system 200 is merely exemplary. While the search engine 210 is illustrated as a single unit, it will be appreciated that the search engine 210 is scalable. For example, the search engine 210 may in actuality include a plurality of computing devices in communication with one another. Moreover, the data store 212, or portions thereof, may be included within, for instance, the search engine 210 as a computer-storage medium. The single unit depictions are meant for clarity, not to limit the scope of embodiments in any form.

As shown in FIG. 2, the search engine 210 comprises a receiving component 218, a semantic unit analysis component 220, and a ranking component 222. In turn, the semantic unit analysis component 220 comprises a syntactical component 224, a topical category component 226, and a translation model component 228. In some embodiments, one or more of the components 218, 220, 222, 224, 226, and 228 may be implemented as stand-alone applications. In other embodiments, one or more of the components 218, 220, 222, 224, 226, and 228 may be integrated directly into the operating system of a computing device such as the computing device 100 of FIG. 1. It will be understood that the components 218, 220, 222, 224, 226, and 228 illustrated in FIG. 2 are exemplary in nature and in number and should not be construed as limiting. Any number of components may be employed to achieve the desired functionality within the scope of embodiments hereof.

The receiving component 218 is configured to receive one or more search queries from a user. The search queries may be inputted on a search engine page, a search box on a Web page, and the like. The search query may comprise one or more terms arranged in a defined grammatical pattern or sequence. Some of the terms may comprise keyword terms, while other terms may join the keyword terms or act as qualifiers of the keyword terms. For the purposes of this application, terms that join keywords are known as joining terms or stop terms. For instance, the search query “books for children” may be considered to have two keywords, “books” and “children,” and a joining word, “for.” The word “for” provides important context for the search query but is often ignored by traditional ranking algorithms. By way of contrast, the search query “books by children” contains the same two keywords as the search query “books for children,” but the joining word “by” completely changes the semantic meaning of the search query. In another example, the presence of a qualifier may change the semantic meaning of the search query. For instance, the search query “non-profit organizations” has a different contextual meaning than the search query “for-profit organizations” although the two search queries share the same keywords. This aspect will be explored in greater depth below.

The semantic unit analysis component 220 is configured to analyze the semantic units associated with the search query received by the receiving component 218 as well as the semantic units associated with the documents stored in association with the data store 212. For the purposes of this application, semantics may be thought of as the meaning of a word or group of words as reflected by the surrounding context (e.g., the surrounding words). Analysis of semantic units associated with the documents may occur offline. In this instance, the entire document, and document corpus, is analyzed to identify one or more semantic units. As well, analysis of semantic units associated with the documents may occur at the time the search query is received (i.e., in real-time). In this case, semantic unit analysis may focus on those sentences and/or context windows that contain the search query keywords. Any and all such aspects are contemplated as being within the scope of the invention.

The semantic unit analysis component 220 comprises in part the syntactical component 224. The syntactical component 224 analyzes syntactical patterns associated with the search query and the documents. The syntactical component 224 may use natural language processing to analyze the search query and the documents. In one aspect, the syntactical component 224 analyzes the search query and the documents using a predefined set of syntactical patterns such as, for example, “A of B,” “A for B,” “A by B,” the presence of negative or positive qualifiers, and the like. Using the example given above, the phrase “books by children” has a different syntactical pattern than the phrase “books for children”—each pattern imparts a different meaning to the phrase. In another example, the phrase “non-profit organization” has a different syntactical pattern and a different contextual meaning than the phrase “for-profit organization” due to the presence of the negative qualifier “non-.” This is true even though both phrases comprise the same keywords “profit” and “organization.”

The semantic unit analysis component 220 further comprises the topical category component 226. The topical category component 226 is configured to identify topical categories associated both with the received search query and the documents in the data store 212. The topical category component 226 may apply natural language processing techniques to identify topical categories. With respect to search queries, the terms of the search query are analyzed to determine a topical category. For instance, a search query of “Microsoft® Office,” or “Word” or “Excel” may belong to the topical category of “software” or “Microsoft® products.” Likewise, the contents of a document are analyzed to identify one or more categories associated with the document. If the majority of the document contents belong to a certain category, the document as a whole may be classified as belonging to that category.

The semantic unit analysis component 220 further comprises the translation model component 228. The translation model component 228 is configured to extract one or more unigrams, bigrams, and/or entities from the search query and one or more unigrams, bigrams, and/or entities from a document(s) stored in the data store 212 and to use a translation model to determine if the query and the document are referencing similar unigrams, bigrams, and/or entities. Entities may be extracted from the search query and the document by using, for example, named entity recognition tools or algorithms that are known in the art. Entities may also be extracted from the search query and the document by utilizing look-up tables that define entities associated with predefined queries and predefined documents.

With respect to unigrams and bigrams, once the unigrams and/or bigrams are extracted from the search query and the document(s), a translation model is used to estimate in a statistical way the relationship between the unigrams/bigrams extracted from the search query and the unigrams/bigrams extracted from the document(s). The relationship may be expressed as a probability that a unigrams/bigrams in the search query can be translated into, or re-expressed by, the unigrams/bigrams in the document(s). For example, if a search query contains the term “software,” and a document contains the term “PowerPoint®,” and the translation model statistically demonstrates that the terms “software” and “PowerPoint®” are strongly related, then the search query is strongly related to the document. The translation model can be trained on different types of parallel text.

With respect to entities, once the entities are extracted from the search query and the document(s), they are mapped to nodes in the entity relationship graph stored in association with the data store 212. For instance, entities extracted from the search query are mapped to a corresponding first set of entity nodes in the entity relationship graph, and entities extracted from the document(s) are mapped to a corresponding second set of entity nodes in the entity relationship graph. A translation model is then utilized to determine a probability that the first set of entity nodes and the second set of entity nodes are related or correlated with each other. A document whose entities have a high probability of being associated with search query entities will be ranked higher in the set of search results.

The translation model for entities comprises a set of probabilities, p(Eᵢ|Eⱼ), i,j=1, 2, . . . , n, where p(Eᵢ|Eⱼ) is the probability entity Eᵢ translates into entity Eⱼ. Given the entity relationship graph, G, with a set of nodes Eᵢ, i=1, 2, . . . , n, a set of probabilities may be determine based on the distance between Eᵢ and Eⱼ in G. The set of probabilities may be further adjusted based on the types of Eᵢ and Eⱼ. For instance, if both Eᵢ and Eⱼ represent a person's name, the probability that the entities are correlated with each other is increased. Thus, for a given query, Q, and document, D, the entities extracted from Q can be represented by the expression QEᵢ, i=1, . . . , k, and the entities extracted from D can be represented by the expression DEᵢ, i=1, . . . , m. The translation model may then be applied to these entities to generate one or more probabilities that entities extracted from Q and D are correlated and likely to occur together. This can be represented by the expression p(QEᵢ|DEⱼ), i=1, . . . , k and j=1, . . . , m.

The semantic unit analysis component 220 may be further configured to extract one or more keywords from the search query and to extract one or more keywords associated with the documents stored in association with the data store 212.

The ranking component 222 is configured to compare the semantic units and/or keywords associated with the search query and the documents and generate semantic ranking features based on a degree of similarity between the semantic units and/or the keywords. For instance, the ranking component 222 is configured to identify documents stored in association with the data store 212 whose semantic units are substantially similar or related to semantic units associated with the search query.

In one aspect, the ranking component 222 is configured to utilize vector space modeling to determine similar syntactic patterns and/or topical categories between the search query and the document(s). Vector space modeling is known in the art and generally comprises using an algebraic model for representing objects, such as text documents, as vectors of identifiers such as syntactic patterns and/or topical categories. The ranking component 222 is further configured to utilize probabilities generated by the translation model component 228 to generate semantic ranking features. The ranking of the documents whose semantic units are substantially similar or related to the semantic units associated with the search query is adjusted to reflect the degree of similarity. By way of example, documents whose semantic units share a high degree of similarity (based on, for example, vector space modeling or translation modeling) with semantic units of the search query will be ranked higher than documents who share less semantic units with the search query.

The ranking component 222 may be configured to further adjust ranking of documents based on keyword similarity between the document(s) and the search query. Again, documents that share substantially similar keywords with the search query may be ranked higher as compared to documents that do not share substantially similar keywords.

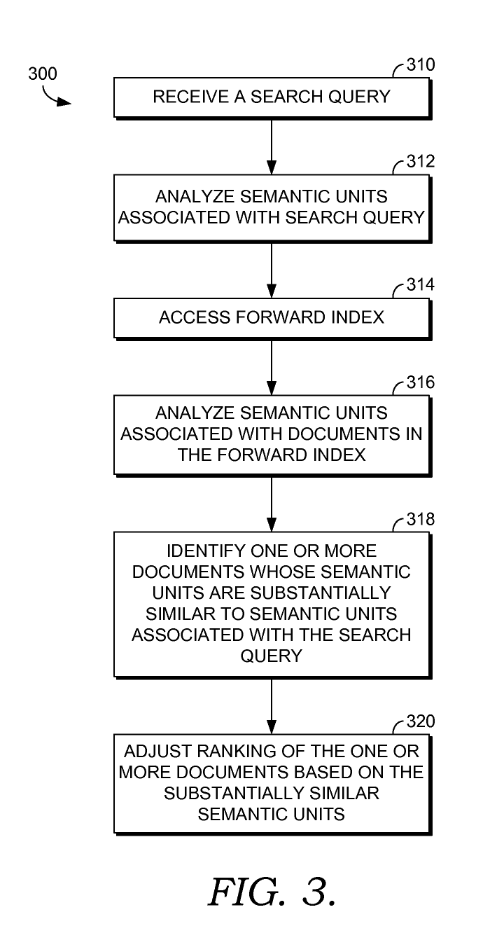

Turning now to FIG. 3, a flow diagram is depicted of an exemplary method 300 of using a forward index to generate semantic ranking features. At a step 310, a search query is received by a receiving component such as the receiving component 218 of FIG. 2. The search query may comprise one or more terms arranged in a grammatical order. For example, the search query may comprise two or more keyword terms joined by one or more joining or “stop” words, or the search query may comprise a keyword term with a qualifier.

At a step 312, semantic units associated with the search query are analyzed by a semantic unit analysis component such as the semantic unit analysis component 220 of FIG. 2. Concurrently with receiving the search query and analyzing the search query for semantic units, a forward index is accessed at a step 314. The forward index comprises a plurality of documents and is structured so that the contextual information of each document is accessible at search time.

At a step 316, semantic units associated with documents in the forward index are analyzed by the semantic unit analysis component. This analysis may occur at the time the search query is received, or the analysis may have previously occurred in an offline setting. Semantic units associated with the search query and the documents provide important indicators as to the underlying meaning of the query and documents. Semantic units include semantic patterns associated with the search query and the documents. The semantic patterns comprise grammatical patterns between keywords and adjoining words and may take into account joining or stop words and qualifiers. Some exemplary joining or stop words may include: by, for, of, and, or, in, on, and the like. These are just a few examples of joining words; any word that joins one or more keywords is contemplated as being within the scope of the invention. Some exemplary qualifiers may include non-, for-, un-, pro-, anti-, and the like. Phrases that have different grammatical patterns may have different meanings even though they share the same keywords (e.g., “books by children” has a different meaning than “books for children” even though they share the same keywords). The analysis of semantic patterns may be based on predefined grammar patterns and may utilize natural language processing.

Semantic units also include topical categories associated with the search query and the documents. The topical categories may comprise broad categories and/or one or more sub-categories. For instance, the search query “Microsoft® Office” may be categorized in the broad category of computer software and may be further categorized in the narrower category of Microsoft® products. Any and all such aspects are contemplated as being within the scope of the invention. With respect to documents, a document may be associated with several categories but have a predominant category. The document as a whole may be categorized as belonging to the predominant category. Natural language processing may be used to determine topical categories associated with the search query and the documents.

Analysis of semantic units may also include extracting one or more unigrams and/or bigrams from the search query and the documents. A translation model is utilized to determine if the unigrams and/or bigrams extracted from the search query are related to the unigrams and/or bigrams extracted from the document(s). If a substantial relationship is determined, then it can be determined that the search query is substantially related to the document(s).

Further, analysis of semantic units includes extracting one or more entities from the search query and the document(s). Entities may be extracted using, for example, a named entity recognition algorithm and/or look-up tables. Using an entity relationship graph, the entities extracted from the search query are mapped to a first set of entity nodes in the entity relationship graph. Likewise, entities extracted from a document are mapped to a second set of entity nodes in the entity relationship graph. A translation model may be used to determine a probability that the first set of entity nodes is correlated or related to the second set of entity nodes based in part on the distance between the first set of entity nodes and the second set of entity nodes in the entity relationship graph. The probability may be further determined based on the type of entity associated with the first set of entity nodes and the second set of entity nodes. For example, if the first set of entity nodes is a location and the second set of entity nodes is also a location, then the probability that the two sets of nodes are related is increased.

At a step 318, documents whose semantic units substantially match or are substantially similar to the semantic units associated with the search query are identified by a ranking component such as the ranking component 222 of FIG. 2. In one aspect, a vector space model is utilized to determine documents who share syntactic patterns and/or topical categories with the search query. Probabilities generated by a translation model are used to determine documents that have unigrams, bigrams, and/or entities that are related to unigrams, bigrams, and/or entities associated with the search query. Further, documents that have keywords that are substantially similar to keywords in the search query may also be identified.

At a step 320, the ranking of documents that share semantic units with the search query is adjusted. In one aspect, documents that share a greater proportion of semantic units with the search query are ranked higher than those documents that share few semantic units with the search query. This may be true even though the search query and the document share similar keywords. Thus, a document that may be ranked higher when using a traditional inverted index based on keyword matching, may be ranked lower when using a forward index because of a lack of similar semantic units. In another aspect, documents whose semantic units are substantially related to semantic units associated with the search query are ranked higher than those documents whose semantic units are less related to semantic units associated with the search query. Any and all such aspects are contemplated as being within the scope of the invention.

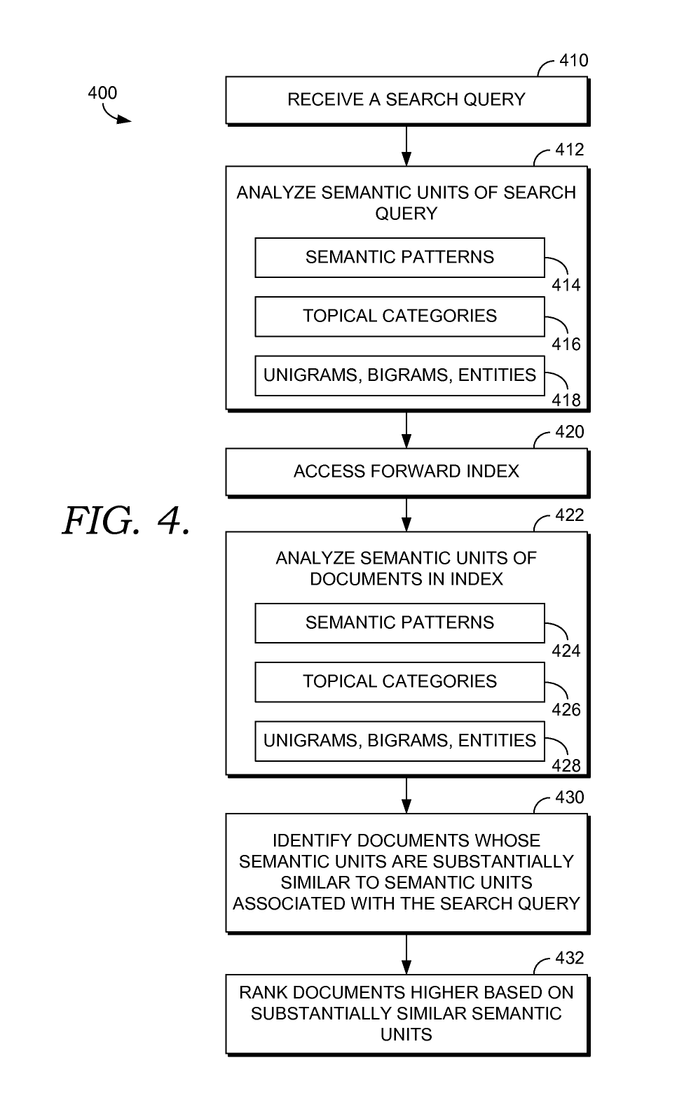

Turning now to FIG. 4, a flow diagram is depicted illustrating an exemplary method 400 of ranking a document on a search engine results page using a forward index. At a step 410, a search query comprising one or more terms is received, and, at a step 412, semantic units associated with the search query are analyzed using, in part, natural language processing. The semantic unit analysis may comprise analyzing semantic patterns associated with the search query at a step 414, determining one or more topical categories associated with the search query at a step 416, and extracting one or more unigrams, bigrams, and/or entities from the search query at a step 418.

At a step 420, a forward or per-document index is accessed. The forward index comprises a data store of documents such as the data store 212 of FIG. 2. The forward index includes contextual information associated with each document in the index and is structured in such a way that each document's contextual information is readily available without significant search-time penalties.

At a step 422, semantic units associated with each document are analyzed. For instance, at a step 424, semantic patterns associated with the documents are analyzed using predefined semantic patterns. At a step 426, one or more topical categories associated with each document are identified. At a step 428, unigrams, bigrams, and/or entities are extracted from the documents, and a translation model is used to determine a degree of relatedness between the search query and the document(s).

At a step 430, one or more documents are identified that share semantic units with the search query. Additionally, documents that share similar keywords with the search query are also identified. At a step 432, documents that share substantially similar semantic units with the search query are ranked higher when returned as a set of search results on a search engine results page. The ranking may be further adjusted based on the similarity of keywords between the search query and the documents.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-readable media storing computer-useable instructions that, when used by one or more computing devices, cause the one or more computing devices to perform a method of generating semantic ranking features using a forward index, the method comprising:
receiving a search query;
analyzing, using the one or more computing devices, one or more semantic units associated with the search query;
accessing a forward index comprising a plurality of documents;
analyzing one or more semantic units associated with each document of the plurality of documents;
identifying one or more documents in the plurality of documents whose one or more semantic units are substantially similar to the one or more semantic units associated with the search query; and
adjusting the ranking of the one or more documents based on the substantially similar one or more semantic units.

2. The media of claim 1, wherein the search query comprises a plurality of terms.

3. The media of claim 2, wherein analyzing the one or more semantic units associated with the search query and the each document comprises one or more selected from the following:
identifying one or more semantic patterns associated with the search query and the each document; and
identifying one or more topical categories associated with the search query and the each document.

4. The media of claim 3, wherein the one or more semantic patterns comprise grammar patterns.

5. The media of claim 4, wherein the one or more grammar patterns comprise one or more joining words or one or more qualifiers.

6. The media of claim 5, wherein the one or more joining words indicate semantic relationships between the plurality of terms.

7. The media of claim 3, wherein analyzing the one or more semantic units associated with the search query further comprises extracting one or more entities from the search query, and wherein analyzing the one or more semantic units associated with the plurality of documents further comprises extracting one or more entities from the each document of the plurality of documents.

8. The media of claim 7, wherein the extraction is accomplished using a named entity recognition algorithm.

9. The media of claim 7, wherein the extraction is accomplished using look-up tables.

10. The media of claim 7, wherein identifying the one or more documents in the plurality of documents whose one or more semantic units are substantially similar to the one or more semantic units associated with the search query comprises in part:
using an entity relationship graph comprising a plurality of entity nodes:
(A) mapping the one or more entities extracted from the search query to a first set of entity nodes, and mapping the one or more entities extracted from the each document of the plurality of documents to a second set of entity nodes,
(B) determining a distance between the first set of entity nodes and the second set of entity nodes, and
(C) determining a probability that the one or more entities extracted from the search query are substantially similar to the one or more entities extracted from the each document based on the distance between the first set of entity nodes and the second set of entity nodes.

11. The media of claim 10, further comprising:
using the entity relationship graph comprising the plurality of entity nodes:
(A) determining a type associated with the first set of entity nodes and a type associated with the second set of entity nodes, and
(B) further determining the probability that the one or more entities extracted from the search query are substantially similar to the one or more entities extracted from the each document based on the type associated with the first set of entity nodes and the type associated with the second set of entity nodes.

12. The media of claim 1, wherein the ranking is adjusted upward.

13. The media of claim 1, wherein the forward index is accessed concurrently with receiving the search query.

14. A system for generating semantic ranking features, the system comprising:
a computing device associated with a search engine having one or more processors and one or more computer-readable storage media; and
a forward index data store coupled with the search engine,
wherein the search engine:
receives a search query;
analyzes one or more semantic units associated with the search query;
analyzes one or more semantic units associated with a set of documents stored in association with the forward index data store;
identifies one or more documents in the set of documents whose semantic units substantially match the one or more semantic units associated with the search query; and
modifies the ranking of the one or more documents based on the substantially matched semantic units.

15. The system of claim 14, wherein each document in the set of documents comprises a full text document.

16. The system of claim 15, wherein contextual order is maintained for the each document.

17. The system of claim 15, wherein the one or more semantic units associated with the search query and the one or more semantic units associated with the set of documents are analyzed, in part, using natural language processing.

18. A computerized method carried out by a search engine running on one or more processors for ranking a document on a search engine results page using a forward index, the method comprising:
receiving a search query;
analyzing, using the one or more processors, one or more semantic units associated with the search query, the one or more semantic units comprising:
(A) one or more semantic patterns associated with the search query,
(B) one or more topical categories associated with the search query, and
(C) one or more entities associated with the search query;
accessing the forward index comprising a plurality of documents;
analyzing one or more semantic units associated with the each document of the plurality of documents, the one or more semantic units comprising:
(A) one or more semantic patterns associated with the each document of the plurality of documents,
(B) one or more topical categories associated with the each document of the plurality of documents, and
(C) one or more entities associated with the each document of the plurality of documents;
identifying one or more documents of the plurality of documents whose one or more semantic units are substantially similar to the one or more semantic units associated with the search query; and
ranking the one or more documents higher based on the substantially similar semantic units.

19. The method of claim 18, further comprising:
identifying one or more keywords associated with the search query;
identifying one or more keywords associated with the each document of the plurality of documents;
identifying one or more documents of the plurality of documents whose one or more keywords are substantially similar to the one or more keywords of the search query; and
adjusting the ranking of the one or more documents based on the substantially similar keywords.

20. The method of claim 18, further comprising:
identifying one or more unigrams or bigrams associated with the search query;
identifying one or more unigrams or bigrams associated with the each document of the plurality of documents;
identifying one or more documents of the plurality of documents whose one or more unigrams or bigrams are substantially similar to the one or more unigrams or bigrams of the search query; and
adjusting the ranking of the one or more documents based on the substantially similar unigrams or bigrams.
